(19) United States
(12) Patent Application Publication
(10) Pub. No.: US 2026/0100063 A1
(43) Pub. Date: Apr. 9, 2026

(54) METHODS AND SYSTEMS FOR AUTOMATICALLY UPDATING MODELS BASED ON DATA DRIFT AND GENERATIVE ARTIFICIAL INTELLIGENCE

(71) Applicant: SK Hynix NAND Product Solutions Corp. (dba Solidigm), Rancho Cordova, CA (US)

(72) Inventors: Rita H. WOUHAYBI, Portland, OR (US); Samudyatha KAIRA, Portland, OR (US); Matt A. YURDANA, Portland, OR (US)

(21) Appl. No.: 18/909,821

(22) Filed: Oct. 8, 2024

(51) Int. Cl. G06V 20/70; G06V 10/26; G06V 10/74; G06V 10/774; G06V 10/776; G06V 10/82; G06V 20/50

(52) U.S. Cl. CPC G06V 20/70; G06V 10/761; G06V 10/774; G06V 10/776; G06V 10/26; G06V 10/82; G06V 20/50

(57) ABSTRACT

A method is implemented for automatically labelling images at a computer system having one or more processors and memory. The computer system obtains a first image including an object, e.g., from a camera disposed at a physical environment. A reference model is applied to process the first image and generate a reference label, e.g., identifying the object in the first image. An image generative model is applied to generate a reference image based on the reference label. In accordance with a determination that the first image and the reference image satisfy a similarity criterion, the computer system labels the first image with the reference label. The first image that is labelled with the reference label is added to a corpus of training data to be used to generate a target model for autonomously monitoring the physical environment.

### TECHNICAL FIELD

This application relates generally to computer technology, and more particularly to methods, systems, devices, and non-transitory computer-readable storage media for automatically annotating training data of a machine learning based model using machine learning techniques.

### BACKGROUND

Large volumes of data are collected at edge devices and must be processed efficiently, especially in applications where the data is used to generate real-time feedback and control mechanisms in cloud-based environments. Machine learning techniques are commonly employed to handle this data, which continuously evolves as the surrounding data environment changes. Continuous learning is used to update machine learning models with new data as their performance begins to drift. However, these models are typically built for specific original use cases, and addressing new data classes can be costly, particularly because they require manual inspection, analysis, and annotation.

### SUMMARY

Accordingly, there is a need to create an efficient data annotation solution that leverages machine learning techniques to automatically label and annotate training data of a data processing model, e.g., when a model or data drift is detected. In some embodiments, generative artificial intelligence techniques are applied to generate one or more candidate labels and generate a reference image based on the one or more candidate labels. The reference image is compared with an input image to select a reference label from the one or more labels candidate based on similarity metrics. The input image may be automatically labelled and used for generating, training, or retraining the data processing model. Some implementations introduce a delay tolerant solution of enriching training data, and may be implemented by an edge device (e.g., a smart device, a client device, a storage device). By these means, a computer system can implement machine learning efficiently with no or little human intervention, particularly when a model and input data evolve to become incompatible, e.g., due to due to an input data drift or the model getting out of date.

In an example, multiple cameras are installed in a warehouse to capture visual data, which are processed by a machine learning model to generate output data or control signals. The output data can be used to monitor operations in the warehouse, and the control signals may be used to control machines (e.g., vehicle, cart, forklift, tools) in the warehouse. For instance, a defect detection model is trained to detect defects on boxes or packages that are handled by the machines in the warehouse. Cardboard boxes wrapped in plastic shrink wrap and metal banding were previously shipped to the warehouse. The warehouse is upgraded to manage products shipped in wooden shipping crates in addition to, or in place of, cardboard boxes. The defect detection model needs to be updated to detect defects associated with a new class of product packages in the visual data captured by the cameras disposed in the warehouse. In some embodiments, the image data are labelled using machine learning, e.g., automatically and without user intervention, and applied to train a model (e.g., the defect detection model) used to generate the output data and control signals associated with the warehouse.

In one aspect, a method for labelling data is implemented at a computer system having one or more processors and memory. The method includes obtaining a first image including an object, the first image associated with a physical environment, applying a reference model to process the first image and generate a reference label, e.g., identifying the object in the first image, and applying an image generative model to generate a reference image based on the reference label. The method further includes in accordance with a determination that the first image and the reference image satisfy a similarity criterion, labelling the first image with the reference label. The method further includes adding the first image that is labelled with the reference label to a corpus of training data to be used to generate (e.g., create, train, retrain) a target model for autonomously monitoring the physical environment.

In some embodiments, the method further includes generating the target model based on the first image and the reference label, generating a target output by the target model, and applying the target output to at least partially automatically control a machine or vehicle to operate in the physical environment. The target model may be generated, trained, or retrained based on the first image and the reference label.

In some embodiments, the method further includes applying the target model to process the first image and generate an intermediate output with a confidence score. The reference model is applied in accordance with a determination that the confidence score does not satisfy a confidence threshold requirement.

In another aspect, some implementations include a computer system that includes one or more processors and memory having instructions stored thereon for performing any of the above methods of labelling data.

In yet another aspect, some implementations include a non-transitory computer readable storage medium storing one or more programs. The one or more programs include instructions, which when executed by one or more processors of a computer system cause the one or more processors to implement any of the above methods of labelling data.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 depicts a representative smart work environment, in accordance with some implementations.

FIG. 2 is an example operating environment in which a smart device interacts with a client device or a server system, in accordance with some implementations.

FIG. 3 is a block diagram illustrating a computer system of a smart work environment, in accordance with some implementations.

FIG. 4 is a block diagram of a machine learning system for training and applying data processing models using machine learning, in accordance with some embodiments.

FIG. 5A is a structural diagram of an example neural network applied to process work data in a data processing model, in accordance with some embodiments.

FIG. 5B is an example node in the neural network, in accordance with some embodiments.

FIG. 6 is a flow diagram of an example process for detecting a damaged package using machine learning, in accordance with some embodiments.

FIG. 7 is a block diagram of an example image labelling system for generating training data for a target model (e.g., a defect detection model shown in FIG. 6), in accordance with some embodiments.

FIGS. 8A and 8B are diagram illustrating two example processes of determining a reference label for a first image, in accordance with some embodiments.

FIG. 9 is a flow diagram of an example data labelling method, in accordance with some embodiments.

Like reference numerals refer to corresponding parts throughout the several views of the drawings.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Various embodiments of this application are directed to methods, systems, devices, non-transitory computer-readable media for automatically labelling training data (e.g., an image) for machine learning. Generative artificial intelligence techniques are applied to determine one or more labels and generate a reference image based on the one or more labels, e.g., when a model or data drift is detected for machine learning based data processing. The reference image is compared with an input image to select a reference label from the one or more labels based on similarity metrics. An input image of a machine learning model may be automatically labelled for generating, training, or retraining the machine learning model. Some implementations introduce a delay tolerant solution of enriching training data and may be implemented by an edge device (e.g., a smart device, a client device, a storage device). By these means, a computer system can implement machine learning efficiently with no or little human intervention, particularly when a model and input data evolve to become compatible, e.g., due to an input data drift or the model getting out of date.

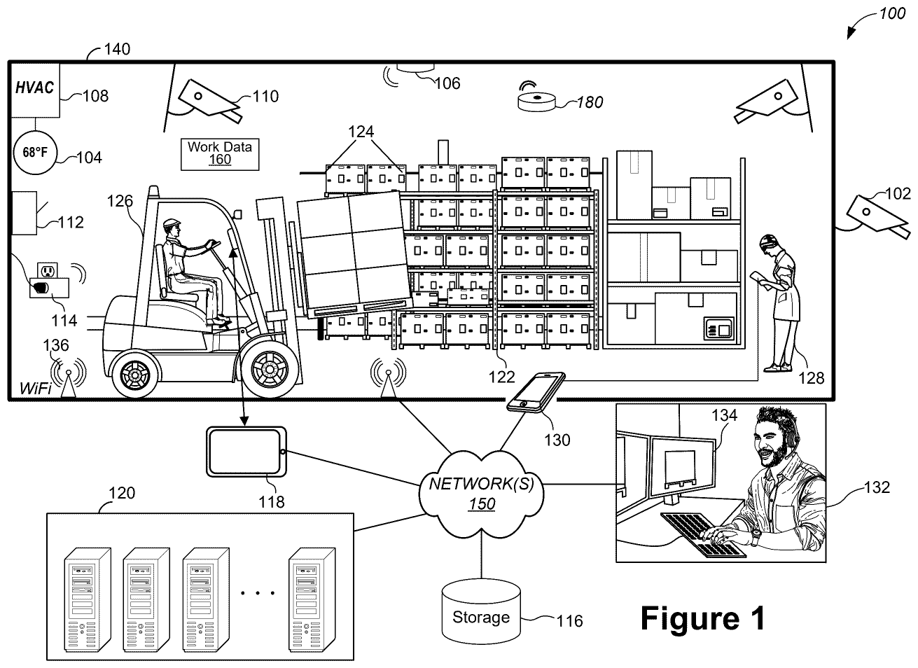

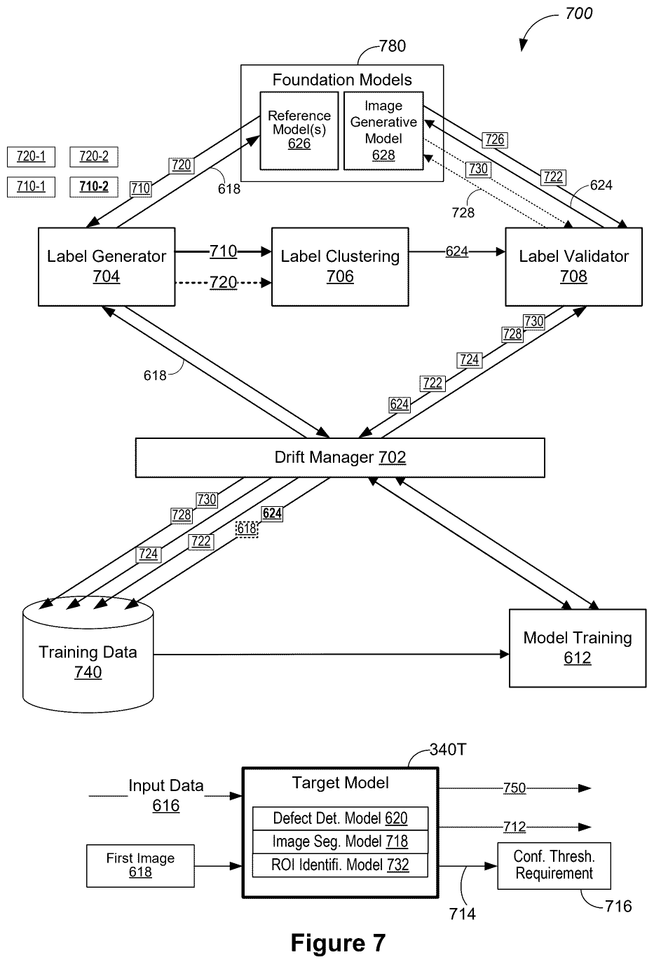

FIG. 1-5B provide background exemplary sensor device networks and capabilities (e.g., machine learning based data processing capabilities) described herein, which are helpful in understanding the details of the embodiments described from FIG. 6 onward.

FIG. 1 depicts a representative smart work environment 100 in accordance with some implementations. The smart work environment 100 includes a structure 140, which may be used as a warehouse, factory, construction site, farm, laboratory, office space, retail store, hospital, and the like. For example, the structure 140 may be used as a distribution center, an e-commerce fulfillment center, an automobile assembly plant, an electronics manufacturing facility, a supermarket, or a retailer store. It will be appreciated that the structure 140 has an open floor plan, high ceilings, and support structures (e.g. columns or beams) and may include different functional areas designed for efficiency, safety, and scalability. Further, the smart work environment 100 may control and/or be coupled to devices outside of the actual structure 140. Indeed, several devices in the smart work environment 100 need not be physically within the structure 140. For example, a surveillance camera 102 may be located outside of the structure 140.

The depicted structure 140 may include a plurality of areas (e.g., storage areas, work areas) that may not be physically separated by walls. The depicted structure 140 may also include rooms (not shown) that are separated from the plurality of areas by walls. Devices may be mounted on, integrated with, and/or supported by a wall, a floor, a ceiling, or a support structure of the structure 140. Alternatively, devices may be mounted on, integrated with, and/or supported by an object (e.g., a shelf 122, a forklift 126) fixed or moveable in the structure 140.

In some implementations, the smart work environment 100 includes a plurality of devices, including intelligent, multi-sensing, network-connected devices, that integrate seamlessly with each other in a network 150 and/or with a central server system 120 or a cloud-computing system to provide a variety of useful smart work functions. The smart work environment 100 may include one or more surveillance cameras 102, one or more intelligent, multi-sensing, network-connected thermostats 104 (“smart thermostats”) and one or more intelligent, network-connected, multi-sensing hazard detection units 106 (“smart hazard detectors”). In some implementations, the smart thermostat 104 detects ambient climate characteristics (e.g., temperature and/or humidity) and controls an HVAC system 108 accordingly. The smart hazard detector 106 may detect the presence of a hazardous substance or a substance indicative of a hazardous substance (e.g., smoke, fire, and/or carbon monoxide). The surveillance cameras 102 may detect a person's or a vehicle's approach to or departure from the structure 140, identify and/or report any abnormal incidents, and/or control settings on a security system (e.g., to activate or deactivate the security system).

In some implementations, the smart work environment 100 includes one or more intelligent, multi-sensing, network-connected wall switches 112 (“smart wall switches”), along with one or more intelligent, multi-sensing, network-connected wall plug interfaces 114 (“smart wall plugs”). The smart wall switches 112 may detect ambient lighting conditions, detect room-occupancy states, and control a power and/or dim state of one or more lights. In some instances, smart wall switches 112 may also control a power state or speed of a fan, such as a ceiling fan. The smart wall plugs 114 may detect occupancy of a room or enclosure and control supply of power to one or more wall plugs (e.g., such that power is not supplied to the plug if nobody is present in the structure 140).

In some implementations, the smart work environment 100 includes a plurality of network-connected cameras 110 that are configured to provide video monitoring and security inside the structure 140. For example, the structure 140 is used as a warehouse, which is a bustling hub of activity, with neatly organized shelves 122 stretching high to accommodate an extensive inventory of product boxes 124. Each shelf 122 is carefully labeled and arranged to maximize space and ensure efficient access to goods. A forklift 126 may navigate the wide aisles with precision, lifting and moving boxes 124 from one location to another with a steady hum of its engine. The forklift 126 may include a computer device 118 for obtaining and updating information of the boxes 124 (e.g., box locations, weights, handling details). A worker 128 may check the stock levels on a handheld device 130, verifying the quantities and ensuring that inventory records match the physical stock. The air is filled with the sounds of the forklift's beeping and the occasional rustle of boxes as the warehouse maintains a routine of receiving, storing, and preparing products for distribution. A plurality of cameras 110 are distributed at different locations in the structure 140, and configured to capture static images or video clips monitoring activities of the forklift 126 and the worker 128.

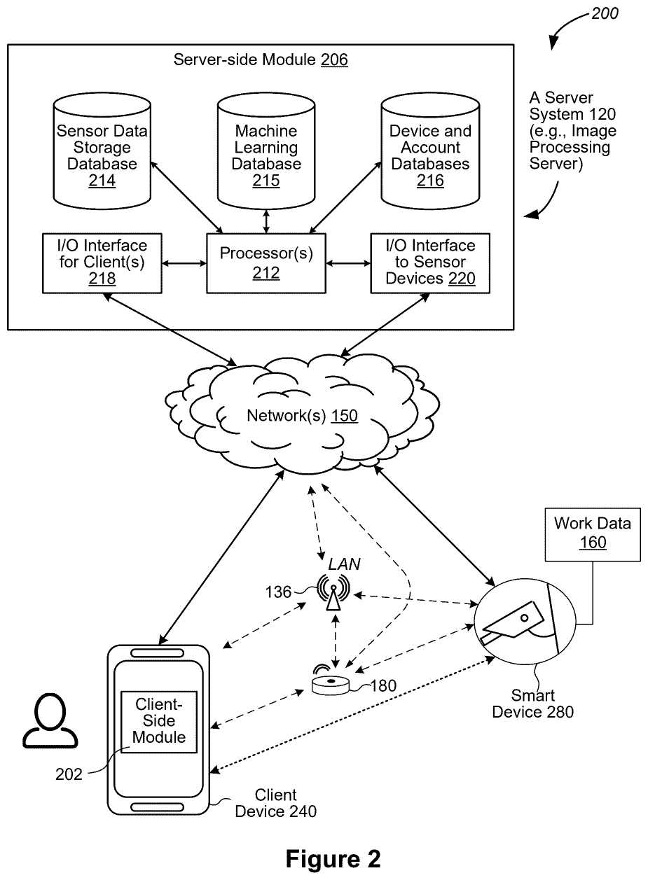

The devices 102-114 (e.g., collectively called smart devices 280 in FIG. 2) are examples of sensors and actuators that are disposed in the smart work environment 100 for collecting work data 160 (e.g., image data captured by cameras 110, temperature data captured by the smart thermostat 104). In some embodiments now shown, a variety of smart devices 280 are used to optimize efficiency and ensure smooth operations in the smart work environment 100. For example, radio frequency identification (RFID) sensors are employed to track products throughout the structure 140, ensuring that items are accurately located and inventoried. Proximity sensors may help robots and autonomous vehicles navigate safely by detecting obstacles and other machines. Infrared and optical sensors are used for barcode scanning, enabling quick identification of products. Additionally, pressure and weight sensors ensure that items are handled carefully and that shipping weights are accurate. Additional environmental sensors monitor conditions such as humidity to protect sensitive products. These technologies work together to create a highly automated and efficient smart work environment 100.

By virtue of network connectivity, one or more of the smart devices 280 may further allow a user to interact with the devices even if a user 132 is not proximate to the devices For example, the user 132 may communicate with a device using a computer device 134 (e.g., a desktop computer, laptop computer, a tablet computer, or other portable electronic device (e.g., a smartphone)). A webpage or application may be configured to receive communications from the user 132 and control the smart devices 280 based on the communications and/or to present information about the device's operation to the user 132.

For example, the user 132 may view a current set point temperature for the smart thermostat 104 and adjust it using the computer device 134. The user 132 may review signature events captured by the camera 110 or adjust settings of the camera 110 using the computer device 134. The user 132 may be physically located within or outside the structure 140 during this remote communication.

As discussed above, users may control the smart thermostat 104 and other smart devices in the smart work environment 100 using a network-connected computer device 134. In some examples, a plurality of employees of a business entity associated with the structure 140 may register their devices 134 with the smart work environment 100. Such registration may be made at a central server 120 to authenticate the employees and/or the devices 134 as being associated with the structure 140 and to give permission to the employees to use the devices 134 to access the smart devices 280 in the structure 140.

Employees may use their registered devices 134 to remotely control the smart devices 280 of the structure 140, e.g., when an employee is at work, on vacation, or at a separate office location. The employee may also use a registered device 134 (e.g., handheld device 130) to control the smart devices 280 when the employee is actually located inside the structure 140, such as when the employee is checking stocking in the warehouse.

In some implementations, in addition to containing processing and sensing capabilities, the devices 102, 104, 106, 108, 110, 112, and/or 114 (“the smart devices”) are capable of data communications and information sharing with other smart devices, a central server or cloud-computing system, and/or other devices that are network-connected. The required data communications may be carried out using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi) and/or any of a variety of custom or standard wired protocols (e.g., CAT6 Ethernet or HomePlug), or any other suitable communication protocol.

In some implementations, the smart devices 280 serve as wireless or wired repeaters. For example, a first one of the smart devices communicates with a second one of the smart devices via a wireless router. The smart devices may further communicate with each other via a connection to one or more networks 150 such as the Internet. Through the one or more networks 150, the smart devices may communicate with a smart work server system 120 (also called a central server system and/or a cloud-computing system herein). In some implementations, the smart work server system 120 may include multiple server systems, each dedicated to data processing associated with a respective subset of the smart devices (e.g., a video server system may be dedicated to data processing associated with camera(s) 110). The smart work server system 120 may be associated with a manufacturer, support entity, or service provider associated with the smart devices 280. In some implementations, the smart work environment 100 relies on a dedicated hub device 180 to manage smart devices 280 located within the smart work environment 100, and a hub device server system associated with the hub device 180 serves as the server system 120.

In some implementations, a user is able to contact customer support using a smart device itself rather than needing to use other communication means, such as a telephone or Internet-connected computer. In some implementations, software updates are automatically sent from the smart work server system 120 to smart devices 280 (e.g., when available, when purchased, or at routine intervals). In some embodiments, the smart work environment 100 further includes a storage 116 for storing data related to the servers 120, smart devices 280, client devices 118, 130, and 134 (e.g., collectively called client device 240 in FIG. 2), and applications executed on the client devices. In some embodiments, the storage 116 includes a plurality of SSDs.

FIG. 2 is an example operating environment 100 in which a smart device 280 (e.g., cameras 110) interacts with a client device 240 (e.g., devices 118, 130, and 134 in FIG. 1) or a server system 120 (e.g., an image processing server), in accordance with some implementations. In the operating environment 200, the server system 120 provides data processing for monitoring and facilitating review of object location/motion associated with imaging device data streams (e.g., raw or processed work data 160) captured by multiple cameras 110 disposed in the structure 140. As shown in FIG. 2, the server system 120 may receive raw or processed work data 160 from smart devices 280 (standalone or integrated) located at various physical locations in the smart work environments 100. Each smart device 280 may be bound to one or more reviewer accounts, and the server system 120 may further process the received work data 160 to obtain information associated with the smart device 280 and the corresponding reviewer accounts. For a camera 110, the obtained information could be object locations, object movements, user gestures, and depth mapping. In some implementations, the server system 120 provides the information to client devices 240 associated with the reviewer accounts. In some implementations, the server system 120 uses the information to control a smart device 280 linked to the reviewer accounts.

In some implementations, the server system 120 is a dedicated image processing server that provides data processing services to cameras 110 and client devices 240 independently of other services provided by the server system 120.

In some implementations, each of the smart devices 280 captures work data 160 using signal detectors and sends the captured work data 160 to the server system 120 substantially in real time. In some implementations, each of the smart devices 280 includes a controller device (e.g., a smart device in which a camera 110 is integrated) that serves as an intermediary between the smart device 280 and the server system 120. The controller device receives the work data 160 from the one or more smart devices 280, optionally performs some preliminary processing on the work data 160, and sends the processed work data 160 to the server system 120 on behalf of the one or more smart devices 280 substantially in real time. In some implementations, each smart device 280 has its own on-board processing capabilities to perform some preliminary processing on the captured work data 160 before sending the processed work data 160 (along with metadata obtained through the preliminary processing) to the controller device and/or the server system 120. In some implementations, the client device 240 located in the smart work environment 100 functions as the controller device to at least partially process the captured work data 160.

In accordance with some implementations, each of the client devices 240 includes a client-side module 202. The client-side module 202 communicates with a server-side module 206 executed on the server system 120 through the one or more networks 150. The client-side module 202 provides client-side functionality for information monitoring, review processing, and communication with the server-side module 206. The server-side module 206 provides server-side functionality for event monitoring and review processing for any number of client-side modules 202, each residing on a respective client device 240. The server-side module 206 also provides server-side functionality for response processing and device control for any number of the smart devices 280.

In some implementations, the server-side module 206 includes one or more processors 212, a sensor data database 214, machine learning database 215, device and account databases 216, an I/O interface 218 to one or more client devices, and an I/O interface 220 to one or more smart devices 280. The I/O interface 218 to one or more clients facilitates the client-facing input and output processing for the server-side module 206. The device and account databases 216 store a plurality of profiles for reviewer accounts registered with the server system 120. A user profile includes account credentials for each reviewer account, and identifies one or more smart devices 280 linked to the reviewer account. In some implementations, the user profile of each reviewer account includes information related to capabilities, device characteristics, and lookup tables for the smart devices 280 linked to the reviewer account. The I/O interface 220 to one or more imaging devices facilitates communications with one or more smart devices 280 (standalone or integrated). The sensor data storage database 214 stores raw or processed work data 160 received from the smart devices 280 and associated information, as well as various types of metadata, such as device characteristics of signal emitters and detectors, lookup tables, modulation signals, and sampling rates. In some implementations, this data is used for generating additional information associated with each reviewer account. The machine learning database 215 stores data used by the server 120, the smart devices 280, or the client devices 240 to process the work data 160 collected by the smart devices 280 based on machine learning. For example, machine learning based data processing models and associated training data are stored in the machine learning database 215.

Client devices 240 include handheld computers, wearable computing devices, personal digital assistants (PDAs), tablet computers, laptop computers, desktop computers, cellular telephones, smart phones, enhanced general packet radio service (EGPRS) mobile phones, media players, navigation devices, game consoles, televisions, remote controls, point-of-sale (POS) terminals, vehicle-mounted computers, ebook readers, or a combination of any two or more of these data processing devices or other data processing devices.

Examples of the one or more networks 150 include local area networks (LANs) and wide area networks (WANs) such as the Internet. In some implementations, the one or more networks 150 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the server system 120 is implemented on one or more standalone data processing devices or a distributed network of computers. In some implementations, the server system 120 employs various virtual devices and/or services of third party service providers (e.g., third-party cloud service providers) to provide the underlying computing resources and/or infrastructure resources of the server system 120. In some implementations, the server system 120 includes handheld computers, tablet computers, laptop computers, desktop computers, or a combination of any two or more of these data processing devices or other data processing devices.

The server-client environment 200 shown in FIG. 2 includes both a client-side portion (e.g., the client-side module 202) and a server-side portion (e.g., the server-side module 206). The division of functionality between the client and server portions of operating environment 200 can vary in different implementations. Similarly, the division of functionality between the smart devices 280 and the server system 120 can vary in different implementations. In some implementations, the client-side module 202 is a thin-client that provides only user-facing input and output processing functions, and delegates other data processing functionality to a backend server (e.g., the server system 120). In some implementations, a smart device 280 is a simple data capturing device that continuously captures and streams work data 160 to the server system 120, with limited local preliminary processing of the data. Although many aspects of the present technology are described from the perspective of a computer system (e.g., system 300) as a whole, the corresponding actions performed by the client device 240 and/or the server system 120 would be apparent to those of skill in the art. Some aspects of the present technology may be described from the perspective of the client device or the server system, and the corresponding actions performed by the server system would be apparent to those of skill in the art. Furthermore, some aspects of the present technology may be performed by the server system 120, the client device 240, and the smart device 280 cooperatively.

It should be understood that the operating environment 200 that involves the server system 120, the client device 240, and the smart device 240 is merely an example. Many aspects of operating environment 200 are generally applicable in other operating environments in which a server system provides data processing for monitoring and facilitating review of data captured by other types of electronic devices.

The smart devices, the client devices, and the server system communicate with each other using the one or more communication networks 150. In an example smart work environment 100, two or more devices (e.g., the network interface device 136, the hub device 180, the client devices 240, and the smart devices 280) are located in close proximity to each other, such that they can be communicatively coupled in the same sub-network via wired connections, a WLAN, or a Bluetooth Personal Area Network (PAN). The Bluetooth PAN is optionally established based on classical Bluetooth technology or Bluetooth Low Energy (BLE) technology. In some implementations, each of the hub device 180, the client device 240, and the smart devices 280 are communicatively coupled to the networks 150 via the network interface device 136.

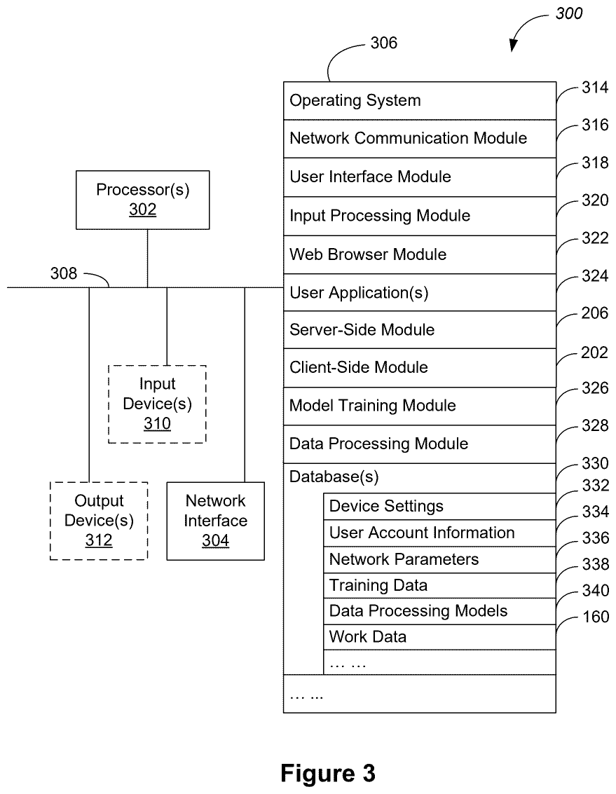

FIG. 3 is a block diagram illustrating a computer system 300 of a smart work environment 100 in accordance with some implementations. The computer system 300 includes a server 120, a client device 240 (e.g., computer device 118, 130, or 134 in FIG. 1), a smart device 280 (e.g., devices 102-114 in FIG. 1), a storage 116, or a combination thereof, and is configured to enable the smart work environment 100. The computer system 300 includes one or more processing units (CPUs) 302, one or more network interfaces 304, memory 306, and one or more communication buses 308 for interconnecting these components (sometimes called a chipset). In some implementations, the computer system 300 includes one or more input devices 310, which facilitate user input, such as a keyboard, a mouse, a voice-command input unit or microphone, a touch screen display, a touch-sensitive input pad, a gesture capturing camera, or other input buttons or controls. In some implementations, the computer system 300 uses a microphone and voice recognition or a camera and gesture recognition to supplement or replace the keyboard. In some implementations, the computer system 300 includes one or more cameras, scanners, or photo sensor units for capturing images. In some implementations, the computer system 300 includes one or more output devices 312, which enable presentation of user interfaces and display content, including one or more speakers and/or one or more visual displays.

The memory 306 includes high-speed random access memory, such as DRAM, SRAM, DDR RAM, or other random access solid state memory devices. In some implementations, the memory 306 includes non-volatile memory, such as one or more magnetic disk storage devices, one or more optical disk storage devices, one or more flash memory devices, or one or more other non-volatile solid state storage devices. In some implementations, the memory 306 includes one or more storage devices remotely located from the processing units 302. The memory 306, or alternatively the non-volatile memory within the memory 306, includes a non-transitory computer readable storage medium. In some implementations, the memory 306, or the non-transitory computer readable storage medium of the memory 306, stores the following programs, modules, and data structures, or a subset or superset thereof:
an operating system 314, which includes procedures for handling various basic system services and for performing hardware dependent tasks;
a network communication module 316, which connects the computer system 300 to other devices (e.g., various servers in the server system 120, a client device, or a smart device) via one or more network interfaces 304 (wired or wireless) and one or more networks 150, such as the Internet, other wide area networks, local area networks, metropolitan area networks, and so on;
a user interface module 318, which enables presentation of information (e.g., a graphical user interface for presenting applications, widgets, websites and web pages thereof, and/or games, audio and/or video content) at a client device 118, 130, and 134;
an input processing module 320 for detecting one or more user inputs or interactions from one of the one or more input devices 310 and interpreting the detected input or interaction;
a web browser module 322 for navigating, requesting (e.g., via HTTP), and displaying websites and web pages thereof, including a web interface for logging into a user account associated with a client device 240 or another electronic device, controlling the client or electronic device if associated with the user account, and editing and reviewing settings and data that are associated with the user account;
one or more user applications 324 for execution by the servers 120 (e.g., smart work applications, and/or other web or non-web based applications);
a server-side module 206, which communicates both with smart work environments 100 and with client-side modules 202 and includes a plurality of individual programs, procedures, modules, and/or objects for performing a variety of functions;
a client-side module 202, which communicates with the server-side module 206 in the smart work environment 100 and includes a plurality of individual programs, procedures, modules, and/or objects for performing a variety of functions;
model training module 326 for receiving training data and establishing one or more data processing models 340 for processing work data 160 (e.g., video, image, audio, or textual data) collected by the smart devices 280;
a data processing module 328 for processing work data 160 using data processing models 340, thereby identifying information contained in the work data 160, matching the work data 160 with other data, categorizing the work data 160, or synthesizing related work data 160; and
one or more databases 330 for storing at least data including one or more of:
   device settings 332 including common device settings (e.g., service tier, device model, storage capacity, processing capabilities, communication capabilities, etc.) of the one or more servers 120, client devices, or smart devices;
   user account information 334 for the one or more user applications 324, e.g., user names, security questions, account history data, user preferences, and predefined account settings;
   network parameters 336 for the one or more communication networks 150, e.g., IP address, subnet mask, default gateway, DNS server and host name;
   training data 338 for training one or more data processing models 340;
   data processing model(s) 340 for processing work data 160 (e.g., video, image, audio, or textual data) using deep learning techniques;
   work data 160 and associated results, where the work data 160 is processed using the data processing models 340 remotely at the server 120 or locally at the client device 240 to provide the associated results to be presented on the client devices or further processed.

In some implementations, the server-side module 206 acts as a control layer or API to the underlying functionality. In some implementations, the server-side module includes one or more of an emitter modulation module, a signal detection module, an object detection module, a location module, a movement module, a depth mapping module, and/or a gesture determination module for a smart device 280. Some implementations implement all of these features at a server system 120, some implementations implement all of these features at the camera 110, and some implementations distribute the functionality between the server 120 and the imaging device (e.g., based on efficiency considerations). In some implementations, the server-side module 206 includes a response processing module, which receives either raw unprocessed signals received at an camera 110 or signals that have been preprocessed by a local response processing module at the camera 110. The response processing module prepares the work data 160 (e.g., time of flight detection data) for use by the location module, the movement module, the depth mapping, and/or the gesture determination module. The server-side module 206 also includes an account administration module, which enables users to set up smart work environments 100 and to identify the smart devices 280 associated with the smart work environment 100.

Although many aspects of the present technology are described from the perspective of a computer system as a whole, the corresponding actions performed by the client device 240 and/or the server system 120 would be apparent to those of skill in the art. The server-side module 206 and the client-side module 202 are implemented at the server 120 and the client device 240, respectively. Each of the other modules 314-328 may be implemented in any of a server 120, a client device 240 (e.g., computer device 118, 130, or 134 in FIG. 1), a smart device 280 (e.g., devices 102-114 in FIG. 1), a storage 116, or a combination thereof.

Each of the above identified elements may be stored in one or more of the previously mentioned memory devices, and corresponds to a set of instructions for performing a function described above. The above identified modules or programs (e.g., sets of instructions) need not be implemented as separate software programs, procedures, modules, or data structures, and thus various subsets of these modules may be combined or otherwise rearranged in various implementations. In some implementations, the memory 306 stores a subset of the modules and data structures identified above. In some implementations, the memory 306 stores additional modules and data structures not described above.

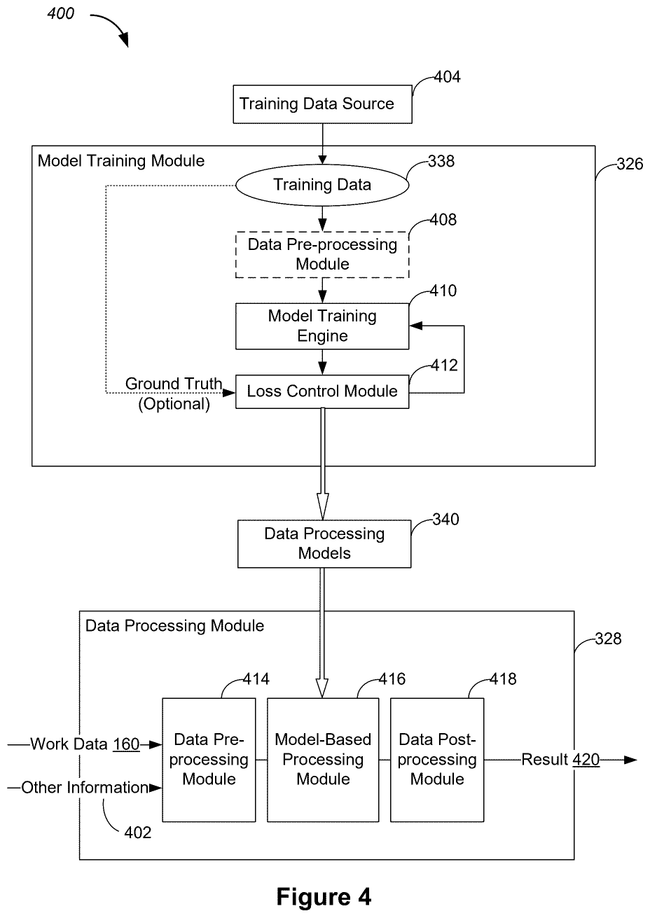

FIG. 4 is a block diagram of a machine learning system 400 for training and applying data processing models 340 using machine learning, in accordance with some embodiments. The machine learning system 400 includes a model training module 326 establishing one or more data processing models 340 and a data processing module 328 for processing data collected by smart devices 280 (e.g., cameras 110) using the data processing model 340. In some embodiments, both the model training module 326 (e.g., the model training module 326 in FIG. 3) and the data processing module 328 are located in the server 120, while a training data source 404 provides training data 338 to the server 120. In some embodiments, the training data source 404 is the data obtained from the smart devices 280, from another server 120, from storage 116, or from a client device. Alternatively, in some embodiments, the model training module 326 (e.g., the model training module 326 in FIG. 3) is located at a server 120, and the data processing module 328 is located in a smart device 280 or a client device 240. The server 120 trains the data processing models 328 and provides the trained models 340 to a smart device 280 or a client device 240 to process real-time work data 160 captured by the smart device 280.

In some embodiments, the training data 338 provided by the training data source 404 include a standard dataset (e.g., a set of work site images) widely used by engineers in an associated industry to train data processing models 340. In some embodiments, the training data 338 includes work data 160 and/or additional work site information, which is collected from one or more smart devices that will apply the data processing models 340 or collected from distinct smart devices that will not apply the data processing models 340. Further, in some embodiments, a subset of the training data 338 is modified to augment the training data 338. The subset of modified training data is used in place of or jointly with the subset of training data 338 to train the data processing models 340.

In some embodiments, the model training module 326 includes a model training engine 410, and a loss control module 412. Each data processing model 340 is trained by the model training engine 410 to process corresponding work data 160.

Specifically, the model training engine 410 receives the training data 338 corresponding to a data processing model 340 to be trained, and processes the training data to build the data processing model 340. In some embodiments, during this process, the loss control module 412 monitors a loss function comparing the output associated with the respective training data item to a ground truth of the respective training data item. In these embodiments, the model training engine 410 modifies the data processing models 340 to reduce the loss, until the loss function satisfies a loss criteria (e.g., a comparison result of the loss function is minimized or reduced below a loss threshold). The data processing models 340 are thereby trained and provided to the data processing module 328 to process work data 160.

In some embodiments, the model training module 326 further includes a data pre-processing module 408 configured to pre-process the training data 338 before the training data 338 is used by the model training engine 410 to train a data processing model 340. For example, an image pre-processing module 408 is configured to format images in the training data 338 into a predefined image format. For example, the preprocessing module 408 may normalize the images to a fixed size, resolution, or contrast level. In another example, an image pre-processing module 408 extracts a region of interest (ROI) corresponding to a target area or object in each image or separates content of the target area or object into a distinct image.

In some embodiments, the model training module 326 uses supervised learning in which the training data 338 is labelled and includes a desired output for each training data item (also called the ground truth in some situations). In some embodiments, the desirable output is labelled manually by people or labelled automatically by the model training model 326 before training. In some embodiments, the model training module 326 uses unsupervised learning in which the training data 338 is not labelled. The model training module 326 is configured to identify previously undetected patterns in the training data 338 without pre-existing labels and with little or no human supervision. Additionally, in some embodiments, the model training module 326 uses partially supervised learning in which the training data is partially labelled.

In some embodiments, the data processing module 328 includes a data pre-processing module 414, a model-based processing module 416, and a data post-processing module 418. The data pre-processing modules 414 pre-processes work data 160 based on the type of the work data 160. In some embodiments, functions of the data pre-processing modules 414 are consistent with those of the pre-processing module 408, and convert the work data 160 into a predefined data format that is suitable for the inputs of the model-based processing module 416. The model-based processing module 416 applies the trained data processing model 340 provided by the model training module 326 to process the pre-processed work data 160. In some embodiments, the model-based processing module 416 also monitors an error indicator to determine whether the work data 160 has been properly processed in the data processing model 340. In some embodiments, the processed work data is further processed by the data post-processing module 418 to create a preferred format or to provide additional work information, associated with the smart work environment 100, which can be derived from the processed work data.

In some embodiments, work data 160 are supplemented with other information 402 (e.g., additional work site information, which is collected from one or more smart devices that will apply the data processing models 340 or collected from distinct smart devices that will not apply the data processing models 340). In some embodiments, the data processing module 328 uses the processed work data (e.g., result 420) to at least partially autonomously control an equipment or tool (e.g., forklift 126 in FIG. 1) that operates in the smart work environment 100. For example, the processed work data includes control instructions that are used by a control system (manned or unmanned) to drive the forklift 126. In some embodiments, the processed work data (e.g., result 420) is applied to at least partially autonomously control a robot operating on a vehicle assembly line or in an electronics manufacturing facility.

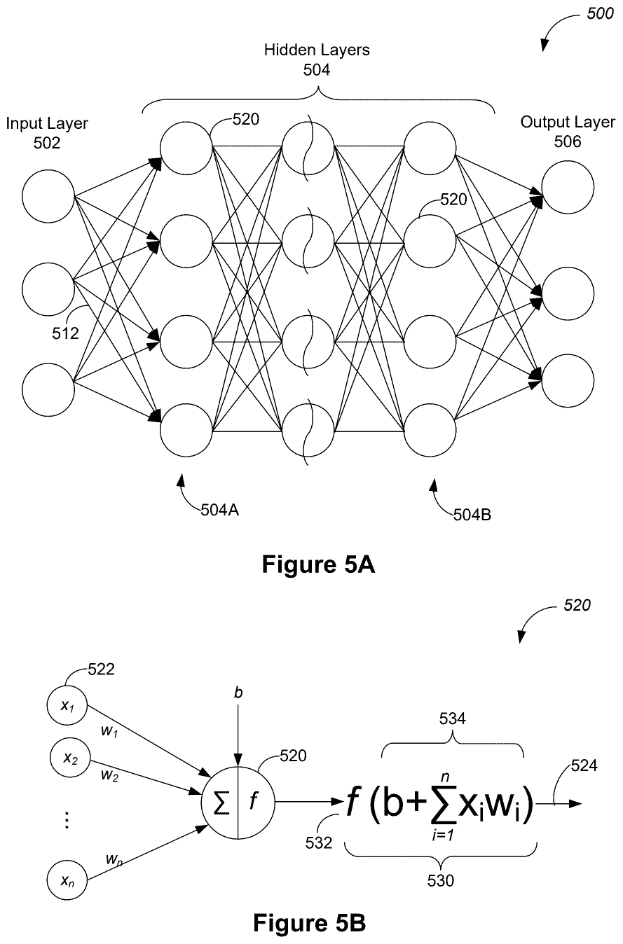

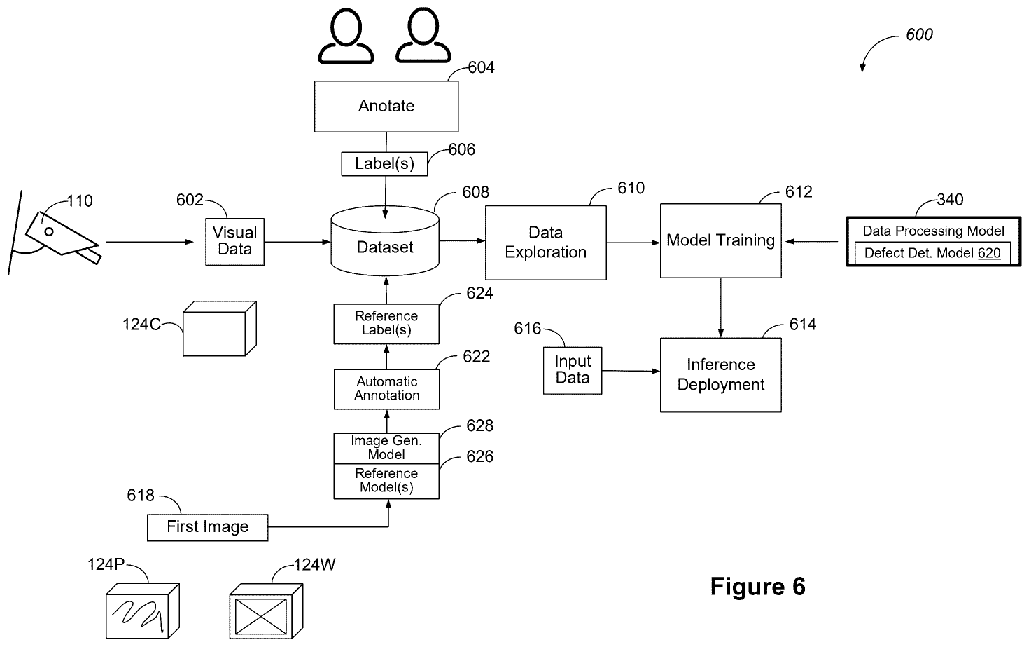

FIG. 5A is a structural diagram of an example neural network 500 applied to process work data in a data processing model 340, in accordance with some embodiments, and FIG. 5B is an example node 520 in the neural network 500, in accordance with some embodiments. It should be noted that this description is used as an example only, and other types or configurations may be used to implement the embodiments described herein. The data processing model 340 is established based on the neural network 500. A corresponding model-based processing module 416 applies the data processing model 340 including the neural network 500 to process work data 160 that has been converted to a predefined data format. The neural network 500 includes a collection of nodes 520 that are connected by links 512. Each node 520 receives one or more node inputs 522 and applies a propagation function 530 to generate a node output 524 from the one or more node inputs. As the node output 524 is provided via one or more links 512 to one or more other nodes 520, a weight w associated with each link 512 is applied to the node output 524. Likewise, the one or more node inputs 522 are combined based on corresponding weights w₁, w₂, w₃, and w₄ according to the propagation function 530. In an example, the propagation function 530 is computed by applying a non-linear activation function 532 to a linear weighted combination 534 of the one or more node inputs 522.

The collection of nodes 520 is organized into layers in the neural network 500. In general, the layers include an input layer 502 for receiving inputs, an output layer 506 for providing outputs, and one or more hidden layers 504 (e.g., layers 504A and 504B) between the input layer 502 and the output layer 506. A deep neural network has more than one hidden layer 504 between the input layer 502 and the output layer 506. In the neural network 500, each layer is only connected with its immediately preceding and/or immediately following layer. In some embodiments, a layer is a “fully connected” layer because each node in the layer is connected to every node in its immediately following layer. In some embodiments, a hidden layer 504 includes two or more nodes that are connected to the same node in its immediately following layer for down sampling or pooling the two or more nodes. In particular, max pooling uses a maximum value of the two or more nodes in the layer for generating the node of the immediately following layer.

In some embodiments, a convolutional neural network (CNN) is applied in a data processing model 340 to process work data (e.g., video and image data captured by cameras 110). The CNN employs convolution operations and belongs to a class of deep neural networks. The hidden layers 504 of the CNN include convolutional layers. Each node in a convolutional layer receives inputs from a receptive area associated with a previous layer (e.g., nine nodes). Each convolution layer uses a kernel to combine pixels in a respective area to generate outputs. For example, the kernel may be to a 3×3 matrix including weights applied to combine the pixels in the respective area surrounding each pixel. Video or image data is pre-processed to a predefined video/image format corresponding to the inputs of the CNN. In some embodiments, the pre-processed video or image data is abstracted by the CNN layers to form a respective feature map. In this way, video and image data can be processed by the CNN for video and image recognition or object detection.

In some embodiments, a recurrent neural network (RNN) is applied in the data processing model 340 to process work data 160. Nodes in successive layers of the RNN follow a temporal sequence, such that the RNN exhibits a temporal dynamic behavior. In an example, each node 520 of the RNN has a time-varying real-valued activation. It is noted that in some embodiments, two or more types of work data are processed by the data processing module 328, and two or more types of neural networks (e.g., both a CNN and an RNN) are applied in the same data processing model 340 to process the work data jointly.

The training process is a process for calibrating all of the weights wᵢ for each layer of the neural network 500 using training data 338 that is provided in the input layer 502. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured (e.g., by a loss control module 412), and the weights are adjusted accordingly to decrease the error. The activation function 532 can be linear, rectified linear, sigmoidal, hyperbolic tangent, or other types. In some embodiments, a network bias term b is added to the sum of the weighted outputs 534 from the previous layer before the activation function 532 is applied. The network bias b provides a perturbation that helps the neural network 500 avoid over fitting the training data. In some embodiments, the result of the training includes a network bias parameter b for each layer.

FIG. 6 is a flow diagram of an example process 600 for detecting a damaged package using machine learning, in accordance with some embodiments. As explained above, a smart work environment 100 includes a physical environment (e.g., a structure 140 in FIG. 1) where shelves 122 are disposed to accommodate an extensive inventory of product boxes 124. A forklift 126 may navigate in the physical environment, lifting and moving boxes 124 from one location. The forklift 126 may include a computer device 118 for obtaining and updating information of the boxes 124 (e.g., box locations, weights, handling details). A worker 128 may check the stock levels on a handheld device 130. The worker 128 may also move or organize the product boxes 124 manually or using a tool (e.g., a cart). A conveyor belt may be applied to transport product boxes 124, e.g., independently or jointly with the worker 128. In some implementations, the smart work environment 100 includes a plurality of network-connected smart devices 280 disposed inside the physical environment for collecting associated work data 160 (e.g., image data captured by cameras 110, temperature data captured by the smart thermostat 104). For example, a plurality of cameras 110 are distributed at different locations in the physical environment, and configured to capture static images or video clips monitoring activities of people (e.g., worker 128), machines (e.g., forklift 126, conveyor belt), and product boxes 124 present in the physical environment. In this application, the static images and video clips may be broadly called “visual data.”

In some embodiments, machine learning is applied to implement a range of tasks, such as object detection, image segmentation, and identification of regions of interest (ROIs). The data processing model 340 includes one or more of: a defect detection model 620, an image segmentation model, an ROI identification model, and a combination thereof. An existing solution for edge deployment of the defect detection model 620 may include model training 612 that is implemented by a model training module 326 (FIG. 3) and relies on human intervention to detect defective cardboard boxes 124C, against which the defect detection model 620 is initially trained.

In some embodiments, machine learning is applied to process the visual data 602 collected by one or more cameras 110. The visual data 602 is annotated (operation 604) with one or more visual labels 606, and stored jointly with the visual label(s) 606 as datasets 608. A computer system 300 (FIG. 3) implements a data exploration process 610 to analyze and understand a structure, quality, and characteristics of a dataset 608 before applying the dataset 608 for training 612 of a data processing model 340 in machine learning. After training, the data processing model 340 is deployed (operation 614) to process input data 616 (e.g., new visual data collected by the one or more camera 110). More details on model training and data inference in machine learning are discussed above with reference to FIGS. 5A and 5B.

In some embodiments, during the data exploration process 610, the computer system 300 determines data types of input data 616 (e.g., numeric, categorical, text, date, image) and output data, a size of the dataset 608 (e.g., number of rows and columns), or associated context information. In some embodiments, the computer system 300 identifies missing data, e.g., using summary statistics, and determines whether and how to create the missing data. In some embodiments, the computer system 300 uses descriptive statistics like mean, median, standard deviation, min, and max values to generate data features. In some embodiments, the computer system 300 identifies one or more outlier data that may need to be handled by removal or capping. In some embodiments, the computer system 300 determines correlation among different data items. In some embodiments, the computer system 300 determines seasonality, trends, and stationarity of time-series data. In some embodiments, the computer system 300 reduces noise and reveal important patterns or clusters in the dataset. In some embodiments, the computer system 300 handles skewness in distributions with log or power transformations, creates data features, or grouping numerical variables into categorical bins. Data exploration 610 may be applied before training the data processing model 340 because it helps understand the dataset's structure and quality, identify potential issues like missing data, outliers, or class imbalance, gain insights into the relationships between features and target variables, and guide preprocessing steps, including data cleaning, feature selection, and transformation.

In some situations, the defect detection model 620 is initially trained to detect defective cardboard boxes 124C. As time goes by, the physical environment on which the defect detection model 620 is deployed starts to handle more items that are not restricted to the cardboard boxes 124C. For example, the input data 616 may include images of a wooden crate box 124W or a plastic wrapped carboard box 124P. The defect detection model 620 needs to be retrained based on new training data associated with the wooden crate box 124W or the plastic wrapped carboard box 124P.

In some embodiments, additional visual data (e.g., a first image 618) may be applied to train the data processing model 340. For example, the first image 618 is automatically annotated (operation 622) with a reference label 624 identifying a defective wooden crate box 124W or a defective plastic wrapped carboard box 124P, e.g., without user intervention. In some embodiments, the computer system applies a reference model 626 to process the first image 618 and generate the reference label 624. The reference label 624 is validated, and applied to annotate the first image 618. During validation, the computer system 300 applies an image generative model 628 to generate a reference image based on the reference label 624, and labels the first image 618 with the reference label 624 when the first image 618 and the reference image satisfies a similarity criterion (e.g., a similarity level of the first image 618 and the reference image 722 being greater than a similarity threshold). The first image 618 labelled with the reference label 624 form a new dataset for model training 612, and is added to a corpus of training data 740 to be used to generate the data processing model 340.

In some embodiments, the first image 618 is annotated automatically and used to train and update the data processing model 340, dynamically and in real-time when the data processing model 340 fails to process the input data 616. The input data 616 includes the first image 618. In accordance with a determination that the data processing model 340 fails to process the input data 616 (e.g. with a low confidence score below a confidence threshold), the computer system 300 annotates the input data 616 automatically for model training 612.

In some embodiments, the data processing model 340 includes a defect detection model 620 for detecting one or more defects on a product box 124 based on at least part of the visual data 602 (e.g., an ROI associated with a product box 124). In some situations, the product box 124 includes a cardboard box 124C, and the dataset 608 is generated based on the visual data 602 associated with the cardboard box 124C. One or more defects associated with the cardboard box 124C are annotated on the visual data 602, and the defect detection model 620 is trained based on the dataset 608 to detect the defects associated with the cardboard box 124C.

In some embodiments, during data inference, the input data 616 are associated with a cardboard box 124P with plastic wrap or a wooden crate box 124W. Each of the plastic-wrapped cardboard box 124P and the wooden crate box 124W may share a common defect with the cardboard box 124C, and have a distinct defect that is rarely or never observed in the cardboard box 124C. In some embodiments, the defect detection model 620 is trained using additional visual data including the plastic-wrapped cardboard box 124P and/or the wooden crate box 124W to detect the distinct defect of the plastic-wrapped cardboard box 124P and/or the wooden crate box 124W. For example, a first image 618 includes one of the plastic-wrapped cardboard box 124P and the wooden crate box 124W. The computer system applies a reference model 626 to process the first image 618 and generate a reference label 624 identifying the distinct defect of the one of the plastic-wrapped cardboard box 124P and the wooden crate box 124W. The reference label 624 is validated using the image generative model 628, and applied to annotate the first image 618 automatically and without user intervention. The first image 618 labelled with the reference label 624 provides a new dataset for model training 612.

Data quality drives performance of the data processing model 340. In some embodiments, additional visual data are automatically annotated and used for model training 612, and the data processing model 340 is adjusted to adapt to input data 616 captured in a dynamically changing environment. Automatic annotation 622 of new training data does not require human involvement, and results in datasets 608 that reflect drifts of the input data 616. Stated another way, automatic annotation 622 allows the data processing model 340 to be updated automatically and maintain its quality in a cost efficient manner, e.g., by avoiding manual annotation of new visual data. During the course of annotating additional training data, generative AI is applied to expand knowledge with the additional training data, which may be associated with diverse types of data caused by a dynamic data drift.

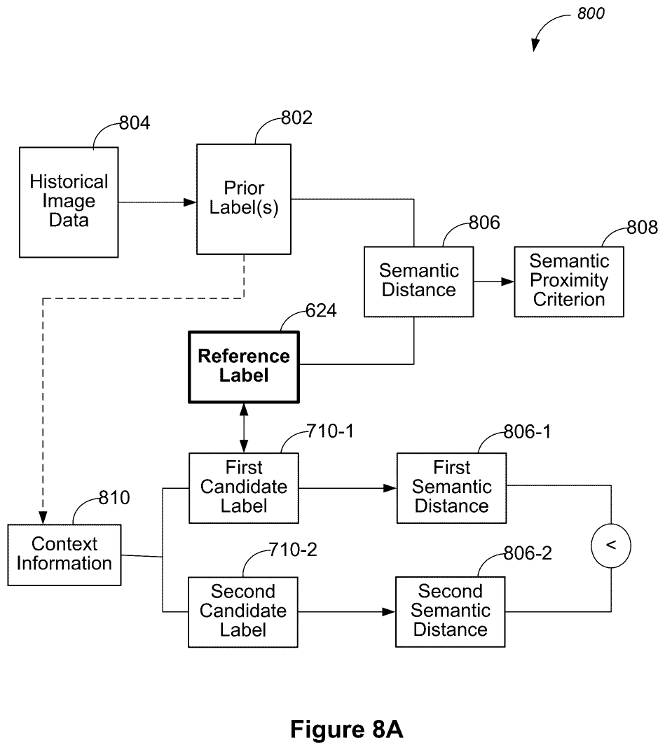

FIG. 7 is a block diagram of an example image labelling system 700 for generating training data for a target model 340T (e.g., a defect detection model 620 shown in FIG. 6), in accordance with some embodiments. The image labelling system 700 is configured to obtain a first image 618 and apply a reference model 626 and an image generative model 628 to create a reference label 624 for the first image 618. The first image 618 labelled with the reference label 624 is added to a corpus of training data 740 to be used to generate (e.g., in model training 612) the target model 340T for autonomously monitoring a physical environment (e.g., detecting a defective product box). The reference model 626 and the image generative model 628 are also collectively called foundation models 780. After training, the target model 340T is applied to generate a target output 750.

In some embodiments, the target output 750 may be applied to at least partially automatically control a machine or vehicle (e.g., forklift 126 in FIG. 1, conveyor belt) to operate in the physical environment. In some situations, the target model 340T is associated with defect detection on the product boxes 124, and the most frequently detected defects are associated with tapes being applied improperly to cause the boxes not fully sealed. The target output 750 includes an instruction to a tape machine to enhance its accuracy for locating box openings and reduce its operation speed for applying tapes onto the box openings. In some situations, the target model 340 detects box deformations of a type of boxes, and the target output 750 includes an instruction to a robotic arm to reduce force applied to handle the type of boxes. In some embodiments, the target model 340T is applied to identify an object in an image. For example, the object is a box containing mustard bottles of glass, and the target output 750 includes an instruction to the forklift 126 to handle the box with caution (e.g., at a reduced speed).

In some embodiments, the image labelling system 700 includes a drift manager 702, a label generator 704, a label clustering module 706, and a label validator 708. Further, in some embodiments, the image labelling system 700 corresponds to a model training module 326 or a data processing module 328 (FIG. 3) of a computer system 300, and the module 326 or 328 further includes the modules 702-708, which are programs when executed by the computer system 300, cause one or more processors 302 of the computer system 300 to label the first image 618 to be used to train the target model 340T.

In some embodiments, the drift manager 702 monitors input data 616 (e.g., the first image 618) and a model output 712 of the target model 340T to determine whether a data or model drift is taking place. Further, in some embodiments, the model output 712 is generated with a confidence score 714. The drift manager 702 determines whether the confidence score 714 satisfies a confidence threshold requirement 716. For example, when the confidence score 714 does not satisfy the confidence threshold requirement 716, the drift manager 702 determines that the input data 616 has drifted compared with training data previously applied to train the target model 340T. In an example, the confidence threshold requirement 716 corresponds to a confidence threshold, and the confidence score 714 satisfies the confidence threshold requirement 716, when the confidence score 714 is greater than the confidence threshold. In some embodiments, the drift manager 702 receives a user input indicating that the input data 616 has drifted compared with the training data previously applied to train the target model 340T. It should be understood that confidence-based or user input-based drift detection methods described herein are merely examples and are that alternative drift detection methods could be performed by the drift manager 702 to detect the data or model drift.

In some embodiments, the target model 340 includes an image segmentation model 718 configured to divide the first image 618 into a plurality of regions each of which corresponds to a class of an object. An intersection over union (IOU) indicator is determined for the model output 712 of the image segmentation model 718, indicating a segmentation quality for distinguishing different objects associated with the plurality of regions. For example, the model output 712 includes a predicted bounding box of an object, and the IOU indicator may be determined based on amount of overlapping between the predicted bounding box of the object and a corresponding ground truth bounding box. The drift manager 702 determines whether the data or model drift occurs to the image segmentation model 718 based on the IOU indicator. For example, the IOU indicator is compared to an IOU threshold. When the IOU indicator is lower than the IOU threshold, the drift manager 702 detects the data or model drift and may request model training 612.

In some embodiments, the drift manager 702 detects a data or model drift, and determines that the input data 616 cannot be processed properly by the target model 340T. The drift manager 702 manages a process to label the input data 616, e.g., with a reference label 624, and use the input data 616 and the reference label 624 to train the target model 340T. For example, the input data 616 includes a first image 618. The drift manager 702 provides the first image 618 to the label generator 704. The label generator 704 sends the first image 618 to one or more reference models 626 to generate one or more candidate labels 710, which include, or are used to generate, the reference label 624 to be used to annotate the first image 618. In some embodiments, the first image 618 is processed using a single reference model 626 to generate the one or more candidate labels 710. Alternatively, in some embodiments, the first image 618 is processed using a plurality of reference model 626 to generate a plurality of candidate labels 710.

In some embodiments, a reference model 626 is applied by the computer system 300 executing a user application associated with the target model 340T. Alternatively, in some embodiments, a reference model 626 is applied by a third-party server 120 external to the computer system 300 executing a user application associated with the target model 340T. The first image 618 is communicated to the third-party server 120, which returns one or more reference labels 624 to the computer system 300. In some embodiments, the computer system 300 may determine that different reference models 626 or associated online services have different trustworthy levels, and are associated with different weighing factors 720, e.g., based on their associated historical responses. In an example, a first candidate label 720-1 is provided by a first reference model and associated with a first weighing factor 720-1, and a second candidate label 710-2 is provided by a second distinct reference model and associated with a second weighing factor 720-2 greater than the first weighing factor 720-1. The second candidate label 710-2 may be selected as the reference label 624 based on the second weighing factor 720-2.

In some embodiments, the label generator 704 provides the one or more candidate labels 710 and associated weighing factors 720, if any, to the label clustering module 706. In some embodiments, the label clustering module 706 consolidates a plurality of candidate labels 710 to generate a single reference label 624, e.g., based on their associated weighing factors 720 or a size of an associated cluster including a plurality of candidate labels 710. In some embodiments, the label clustering module 706 consolidates a first number of candidate labels 710 to generate a second number of reference labels 624, and the first number is greater than the second number (which is greater than 1). Each of the reference labels 624 may be assigned with a respective factor based on the first number (e.g., corresponding to the size of the cluster) and the weighting factors 720 of the candidate labels 710.

In some embodiments, the candidate labels 710 include a first candidate label 710-1 and a second candidate label 720-2 identifying the object in the first image 618.

Keywords in the first candidate label 710-1 and the second candidate label 710-2 are combined to generate a reference label 624. For example, two different adjectives of the candidate labels 710 are extract to contribute to the reference label 624. The image generative model 626 is applied to receive the reference label 624 and generate the reference image 722 based on the reference label 624.

In some embodiments, the label validator 708 is coupled to the label clustering module 706, and applies an image generative model 724 to generate a reference image 722 based on the reference label 624. The reference image 722 is compared with the first image 618, e.g., to determine a similarity level. In accordance with a determination that the first image 618 and the reference image 722 satisfy a similarity criterion (e.g., the similarity level being greater than a similarity threshold), the reference label 624 is validated, and applied to annotate the first image 618. In some embodiments, the computer system 300 executes a user application associated with the target model 340T, and includes the label validator 708. The image generative model 724 is applied within the computer system 300. Alternatively, in some embodiments, the image generative model 724 is applied by a third-party server 120 external to the computer system 300. The label validator 708 sends the reference label 624 to the third-party server 120, which returns one or more reference images 722 to the label validator 708 executed in the computer system 300 (specifically, the label validator 708) for comparison with the first image 618.

In other words, some implementations include a combination of the label generator 704, label clustering module 706, and label validator 708, which is configured to obtain one or more first images 618 captured from a physical environment, create a plurality of reference labels 624, cluster or group the plurality of reference labels 624, and/or validate relevance of the plurality of reference labels 624 to the first image(s) 618.

After the first image 618 is annotated with a reference label 624, the drift manager 702 adds the first image 618 labeled with the reference label 624 to a corpus of training data 740 to be used to generate (e.g., train) the target model 340T for autonomously monitoring the physical environment. In some embodiments, the computer system 300 acts as a machine learning system, and the target model 340T is deployed at a client device 240 or a smart device 280 (e.g., a camera 110) to process the first image 618 during data inference. The first image 618 and the reference label 624 are provided to a server where the target model 340T is trained. After training, the trained target model 340T is updated on the client device 240 or the smart device 280 for use in data processing. Alternatively, in some embodiments, the target model 340T is trained and applied at the server 120. The first image 618 is collected from a camera 110, and applied at the server 120 to determine the reference label 624 and train the target model 340, which is further applied at the server 120 to process more images.

In some embodiments, the reference image 722 that is generated based on the reference label 624 is added to the corpus of training data 740 to be used to generate (e.g., train) the target model 340T. In some embodiments, the label validator 708 applies the image generative model 628 to generate a second image 726 based on the reference label 624. The second image 726 is added to the corpus of training data 740 to be used to generate (e.g., train or retrain) the target model 340T. Additionally, in some embodiments, the label validator 708 generates a test label 728 of a new class, and obtains a test image 730 that is generated by the image generative model 628 based on the test label 728. The test label 728 and the test image 730 may be added to the corpus of training data 740 to be used to generate (e.g., train or retrain) the target model 340T. In some implementations, generation of the test label 728 and the test image 730 is triggered (e.g., by a model training module 326) during model training 612, in accordance with a determination that a model training process does not converge. In some embodiments, the first image 618 has description information and metadata, and the test label 728 is extracted from the description information or the metadata the first image 618, e.g., by a captioning model.

Examples of the image generative model 628 include, but are not limited to, a generative adversarial network (GAN) (e.g., deep convolutional GAN, StyleGAN, CycleGAN, progressive GAN, BigGAN), a diffusion model (e.g., DALL-E 2, Stable Diffusion, Imagen), a transformer-based model, and a vision language model (VLM). In some embodiments, the image generative model 628 is based on a diffusion model with contrastive language-image pretraining (CLIP) for image-text alignment. In some embodiments, the image generative model 628 uses a latent diffusion model to process text descriptions and create images. In some embodiments, the image generative model 628 uses a diffusion model with a focus on understanding language and generating highly accurate visuals. In some embodiments, CLIP is used for text understanding, and vector quantized GAN (VQGAN) generates images. In some embodiments, the image generative model 628 uses CLIP and a generative network to interpret text descriptions and produce corresponding visuals. In some embodiments, the image generative model 628 uses a GAN-based architecture with an attention mechanism for interpreting textual descriptions. In some embodiments, the image generative model 628 includes a GAN-based model that uses contrastive learning to better align text and image representations. In some embodiments, the image generative model 628 includes a transformer-based architecture that mimics autoregressive models for text-to-image generation. In some embodiments, the image generative model 628 uses a GAN-based model configured for fine-grained control over facial attributes based on textual inputs. In some embodiments, the image generative model 628 uses deep neural networks to interpret user input and generate anime-style images.

In some embodiments, the label validator 708 obtains one or more reference labels 624 and generates a query based on the one or more reference labels 624. The query is used as an input to the image generative model 628. The label validator 708 may obtain a template (e.g., selected from a set of predefined templates) and generate the query by combining the reference label(s) 624 and the template.

Referring to FIG. 7, in some embodiments, synthetic data (e.g., images 722, 726, and 730) are used to augment and enrich the corpus of training data 740. For the defect detection model 620, the synthetic data include image associated with both good product boxes 124 having no defects and defective product box 124, thereby generalizing object classes. In some embodiments, training data 740 are augmented based on the reference model 626 or the image generative model 628 for an image segmentation model 718 or an ROI identification model 732. In some embodiments, metadata associated with an existing class (e.g., a product box having a defect) is used to generate the synthetic data for defective product boxes. The training data 740 may be augmented using the image generative model 626 and used to train the target model 340T, until a desirable model accuracy is reached for the target model 340T. Upon reaching the desirable model accuracy, the target model 340T is deployed in the computer system 300 for data inference at an edge device (e.g., client device 240, smart device 280) or at a server 120.

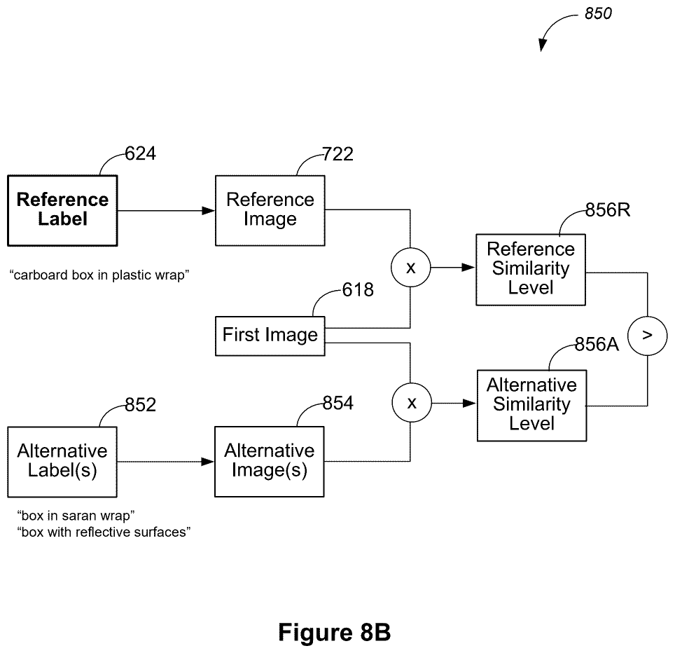

FIGS. 8A and 8B are diagram illustrating two example processes 800 and 850 of determining a reference label 624 for a first image 618, in accordance with some embodiments. Referring to FIG. 8A, in some embodiments, one or more prior labels 802 are determined based on historical image data 804 previously captured for the physical environment, and a semantic distance 806 is determined between the reference label 624 and the one or more prior labels 802. The image generative model 626 is applied to process the reference label 624 in accordance with the semantic distance 8906 satisfies a semantic proximity criterion 808 (e.g., requiring selection of a smallest semantic distance). For example, semantic distances are also determined between each of one or more other candidate labels and the prior labels 802, and are greater than the semantic distance of the reference label 624. The reference label 624 is therefore selected based on the semantic proximity criterion 808. In some situations, the target model 340T includes an object detection model. For a new object that is never seen before, the reference model 624 helps recognize the reference label 624 for the new object, and the image generative model 626 helps provide the reference image 722 associated with the new object for comparison. The semantic distance 806 is applied to control the reference label 624 to be close to the historical image data 804 processed by the target model 340T.

In some embodiments, the reference label 624 includes a first candidate label 710-1, and a second candidate label 720-2 is generated by the reference model 626. The reference label 624 is selected between the first candidate label 710-1 and the second candidate label 710-2 based on context information 810 associated with the physical environment. For example, the computer system 300 is associated with a retail store. The first candidate label 710-1 is “bottled water,” and the second candidate label 710-2 is “oil tank.” The second candidate label 710-2 is far from the context associated with the retail store. The first candidate label 710-1 is selected and included in the reference label 624, and fed to the image generative model 628 to generate the reference image 722.

Further, in some embodiments, the context information 810 associated with the physical environment includes a prior label 802 associated with image data 804 previously captured for the physical environment. A first semantic distance 806-1 between the first candidate label 710-1 and the prior label 802, and a second semantic distance 806-2 is determined between the second candidate label 710-2 and the prior label 802. The first candidate label 710-1 is selected in accordance with a determination that the first semantic distance 806-1 is less than the second semantic distance 806-2.

Additionally, in some embodiments, the second candidate label 710-2 is generated using the same reference model as the first candidate label 710-1. Conversely, in some embodiments, the reference model 626 includes a first reference model, and the second candidate label 710-2 is generated using a second reference model distinct from the first reference model.

Referring to FIG. 8B, in some embodiments, the label validator 708 preliminarily identifies, and provides to the image generative model 628, more than one labels including the reference label 624 identified for the first image 618 and one or more alternative labels 852. The image generative model 628 provides one or more alternative images 854 in addition to the reference image 722 based on one or more alternative labels 852. For each of the reference image 722 and the one or more alternative images 854, the label validator 708 determines a respective similarity level 856R or 856A with the first image 618. The reference image 722 is selected among the reference image 722 and the one or more alternative images 854, so is its associated reference label 624 selected, in accordance with a determination that a reference similarity level 856R of the reference image 722 is higher than an alternative similarity level 856A of each alternative image 854. In an example, the first image 618 includes a cardboard box 124P wrapped in plastic, and is processed by more than one reference model 626 to result in three labels (including a reference label 624), e.g., “carboard box in plastic wrap,” “box in saran wrap,” “box with reflective surfaces.” These three labels are applied to the image generative model 628 to generate three images (including a reference image 722). The image corresponding to “cardboard box in plastic wrap” has a greatest similarity level compared with the other two images corresponding to “box in saran wrap” and “box with reflective surfaces,” and is identified as the reference image 722. As such, the first image 618 is annotated with “cardboard box in plastic wrap” corresponding to the reference image 722.

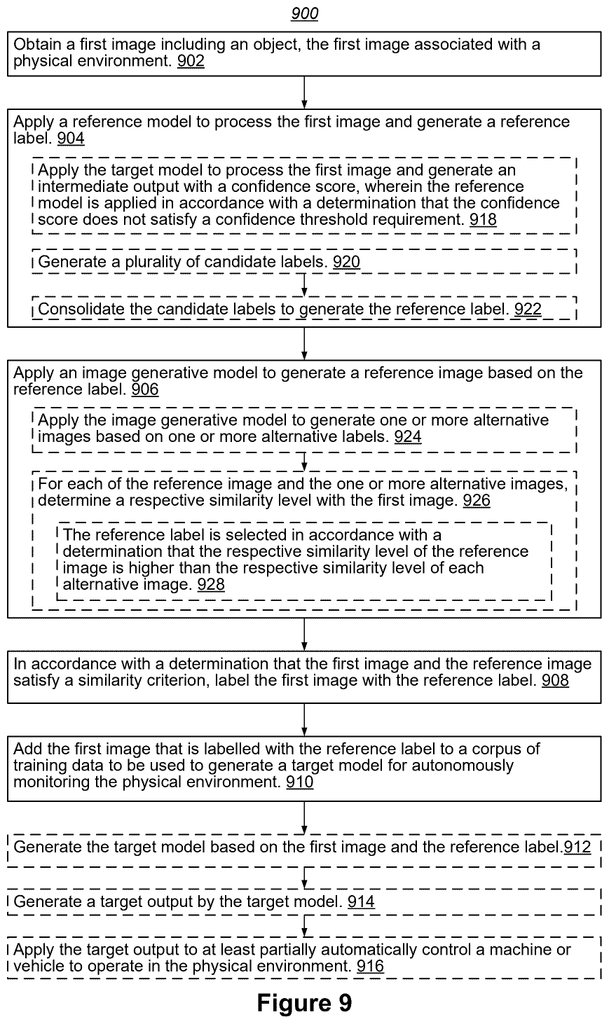

FIG. 9 is a flow diagram of an example data labelling method 900, in accordance with some embodiments. For convenience, the method 900 is described as being implemented by a computer system 300 (e.g., a server 120, a client device 240, a smart device 280, or a combination thereof). Method 900 is, optionally, governed by instructions that are stored in a non-transitory computer readable storage medium and that are executed by one or more processors of the computer system. Each of the operations shown in FIG. 8 may correspond to instructions stored in a computer memory or non-transitory computer readable storage medium (e.g., memory 306 in FIG. 3). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 900 may be combined and/or the order of some operations may be changed.

The computer system 300 obtains (operation 902) a first image 618 including an object, the first image 618 associated with a physical environment, applies (operation 904) a reference model 626 to process the first image 618 and generate a reference label 624, e.g., identifying the object in the first image 618, and applies (operation 906) an image generative model 628 to generate a reference image 722 based on the reference label 624. In accordance with a determination that the first image 618 and the reference image 722 satisfy a similarity criterion, the computer device 300 labels (operation 908) the first image 618 with the reference label 624. The first image 618 that is labelled with the reference label 624 is added (operation 910) to a corpus of training data 740 to be used to generate a target model 340T for autonomously monitoring the physical environment.

The computer system 300 obtains (operation 902) a first image 618 including an object, the first image 618 associated with a physical environment, applies (operation 904) a reference model 626 to process the first image 618 and generate a reference label 624 identifying the object in the first image 618, and applies (operation 906) an image generative model 628 to generate a reference image 722 based on the reference label 624. In accordance with a determination that the first image 618 and the reference image 722 satisfy a similarity criterion, the computer device 300 labels (operation 908) the first image 618 with the reference label 624. The first image 618 that is labelled with the reference label 624 is added (operation 910) to a corpus of training data 740 to be used to generate a target model 340T for autonomously monitoring the physical environment.

In some embodiments, the computer system 300 generates (operation 912) the target model 340T based on the first image 618 and the reference label 624. A target output 750 is generated (operation 914) by the target model 340T, and applied (operation 916) to at least partially automatically control a machine or vehicle to operate in the physical environment.

In some embodiments, the computer system 300 applies (operation 918) the target model 340T to process the first image 618 and generate an intermediate output 712 with a confidence score 714. The reference model 626 is applied in accordance with a determination that the confidence score 714 does not satisfy a confidence threshold requirement 716 (e.g., the confidence score 714 greater than a confidence threshold).

In some embodiments, the target model 340T including an image segmentation model 718. The computer system 300 applying the target model 340T to process the first image 618 and generate an intermediate output with an intersection over union (IOU) indicator. The reference model 626 is applied in accordance with a determination that the IOU indicator is lower than an IOU threshold.

In some embodiments (e.g., associated with FIG. 8A), the computer system 300 identifies one or more prior labels 802 associated with image data 804 previously captured for the physical environment, and determines a semantic distance 806 between the reference label 624 and the one or more prior labels 802. The image generative model 628 is applied in accordance with the semantic distance 806 satisfies a semantic proximity criterion.

In some embodiments (e.g., associated with FIG. 8A), the reference label 624 includes a first candidate label 710-1. The computer system 300 generates a second candidate label 710-2, and selects the first candidate label 710-1 (e.g., to be included in the reference label 624) between the first candidate label 710-1 and the second candidate label 710-2 based on context information 810 associated with the physical environment. Further, in some embodiments, the context information 810 associated with the physical environment includes a prior label 802 associated with image data 804 previously captured for the physical environment. The computer system 300 determines a first semantic distance 806-1 between the first candidate label 710-1 and the prior label 802 and a second semantic distance 806-2 between the second candidate label 710-2 and the prior label 802. The first candidate label 710-1 is selected and included in the reference label 624 in accordance with a determination that the first semantic distance 624-1 is less than the second semantic distance 624-2. In some embodiments, the second candidate label 710-2 is generated using the reference model 626. Conversely, in some embodiments, the reference model 626 includes a first reference model generating the first reference label 624-1, and the second candidate label 710-2 is generated using a second reference model distinct from the first reference model.

In some embodiments, the computer system 300 applies the reference model 626 to process the first image 618 and generate the reference label 624 by applying a first model to process the first image 618 and generate a first candidate label 710-1 with a first weighing factor 720-1 (FIG. 7), applying a second model to process the first image 618 and generate a second candidate label 710-2 with a second weighing factor 720-2, and selecting the reference label 624 between the first candidate label 710-1 and the second candidate label 710-1 based on the first weighing factor 720-1 and the second weighing factor 720-2.

In some embodiments, the computer system 300 applies the reference model 626 to process the first image 618 and generate the reference label 624 by generating (operation 920) a plurality of candidate labels 710 and consolidating (operation 922) the plurality of candidate labels 710 to generate the reference label 624.

In some embodiments, the computer system 300 determines a similarity level between the first image 618 and the reference image 722. In accordance with a determination that the similarity level is greater than a similarity threshold, the computer device 300 determines that the similarity criterion is satisfied.

In some embodiments, the computer system 300 adds the reference image 722 that is generated based on the reference label 624 to the corpus of training data 740 to be used to generate the target model 340T. In some embodiments, the computer system 300 applies the image generative model 628 to generate a second image 726 based on the reference label 624 and adds the second image 726 to the corpus of training data 740 to be used to generate the target model 340T. In some embodiments, the computer system 300 obtains a test label 728 corresponding to an object class, applies the image generative model 628 to generate a test image 730 based on the test label 728, and adds the test image 730 and the test label 728 to the corpus of training data 740 to be used to generate the target model 340T. Further, in some embodiments, the first image 618 has description information and metadata, and the computer system 300 obtains the test label 728 corresponding to the object class by extracting the test label 728 from the description information or metadata of the first image 618.

In some embodiments, the computer system 300 generates a first candidate label 710-1 and a second candidate label 710-2, and both of the candidate labels 710-1 and 710-2 identify the object in the first image 618. Keywords are extracted from the first candidate label 710-1 and the second candidate label 710-2, and combined to generate the reference label 624 applied by the image generative model 628 to generate the reference image 722.

In some embodiments (e.g., associated with FIG. 8B), the computer system 300 applies (operation 924) the image generative model 628 to generate one or more alternative images 854 based on one or more alternative labels 852. For each of the reference image 722 and the one or more alternative images 854, the computer system determines (operation 926) a respective similarity level 856R or 856A with the first image 618. The reference label 624 is selected (operation 928) in accordance with a determination that the respective similarity level 856R of the reference image 722 is higher than the respective similarity level 856A of each alternative image 854.

It should be understood that the particular order in which the operations in FIG. 9 have been described are merely exemplary and are not intended to indicate that the described order is the only order in which the operations could be performed. One of ordinary skill in the art would recognize various ways to enhance speech quality. Additionally, it should be noted that details of other processes described above with respect to FIGS. 1-7 are also applicable in an analogous manner to method 900 described above with respect to FIG. 9. For brevity, these details are not repeated here.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,”depending on the context.

It is also to be appreciated that while the terms user may be used to refer to the person or persons acting in the context of some particularly situations described herein, these references do not limit the scope of the present teachings with respect to the person or persons who are performing such actions. Importantly, while the identity of the person performing the action may be germane to a particular advantage provided by one or more of the implementations, such identity should not be construed in the descriptions that follow as necessarily limiting the scope of the present teachings to those particular individuals having those particular identities.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A method for labelling data, comprising:
at a computer system having one or more processors and memory:
obtaining a first image including an object, the first image associated with a physical environment;
applying a reference model to process the first image and generate a reference label;
applying an image generative model to generate a reference image based on the reference label;
in accordance with a determination that the first image and the reference image satisfy a similarity criterion, labelling the first image with the reference label; and
adding the first image that is labelled with the reference label to a corpus of training data to be used to generate a target model for autonomously monitoring the physical environment.

2. The method of claim 1, further comprising:
generating the target model based on the first image and the reference label;
generating a target output by the target model; and
applying the target output to at least partially automatically control a machine or vehicle to operate in the physical environment.

3. The method of claim 1, further comprising:
applying the target model to process the first image and generate an intermediate output with a confidence score, wherein the reference model is applied in accordance with a determination that the confidence score does not satisfy a confidence threshold requirement.

4. The method of claim 1, the target model including an image segmentation model, the method further comprising:
applying the target model to process the first image and generate an intermediate output with an intersection over union (IOU) indicator, wherein the reference model is applied in accordance with a determination that the IOU indicator is lower than an IOU threshold.

5. The method of claim 1, further comprising:
identifying one or more prior labels associated with image data previously captured for the physical environment; and
determining a semantic distance between the reference label and the one or more prior labels, wherein the image generative model is applied in accordance with the semantic distance satisfies a semantic proximity criterion.

6. The method of claim 1, wherein the reference label includes a first candidate label, the method further comprising:
generating a second candidate label; and
selecting the first candidate label between the first candidate label and the second candidate label based on context information associated with the physical environment.

7. The method of claim 6, wherein the context information associated with the physical environment includes a prior label associated with image data previously captured for the physical environment, the method further comprising:
determining a first semantic distance between the first candidate label and the prior label; and
determining a second semantic distance between the second candidate label and the prior label, wherein the first candidate label is selected and included in the reference label in accordance with a determination that the first semantic distance is less than the second semantic distance.

8. The method of claim 6, wherein the second candidate label is generated using the reference model.

9. The method of claim 6, wherein the reference model comprises a first reference model, and the second candidate label is generated using a second reference model distinct from the first reference model.

10. The method of claim 1, applying the reference model to process the first image and generate the reference label further comprising:
applying a first model to process the first image and generate a first candidate label with a first weighing factor;
applying a second model to process the first image and generate a second candidate label with a second weighing factor; and
selecting the reference label from the first candidate label and the second candidate label based on the first weighing factor and the second weighing factor.

11. The method of claim 1, applying the reference model to process the first image and generate the reference label further comprising:
generating a plurality of candidate labels; and
consolidating the plurality of candidate labels to generate the reference label.

12. The method of claim 1, further comprising:
determining a similarity level between the first image and the reference image; and
in accordance with a determination that the similarity level is greater than a similarity threshold, determining that the similarity criterion is satisfied.

13. The method of claim 1, further comprising:
adding the reference image that is generated based on the reference label to the corpus of training data to be used to generate the target model.

14. The method of claim 1, further comprising:
applying the image generative model to generate a second image based on the reference label; and
adding the second image to the corpus of training data to be used to generate the target model.

15. The method of claim 1, further comprising:
obtaining a test label corresponding to an object class;
applying the image generative model to generate a test image based on the test label; and
adding the test image and the test label to the corpus of training data to be used to generate the target model.

16. The method of claim 15, wherein the first image has description information and metadata, obtaining the test label corresponding to the object class further comprising:
extracting the test label from the description information or metadata of the first image.

17. The method of claim 1, further comprising:
generating a first candidate label identifying the object in the first image;
generating a second candidate label identifying the object in the first image; and
combining keywords in the first candidate label and the second candidate label to generate the reference label applied by the image generative model to generate the reference image.

18. The method of claim 1, further comprising:
applying the image generative model to generate one or more alternative images based on one or more alternative labels; and
for each of the reference image and the one or more alternative images, determining a respective similarity level with the first image;
wherein the reference label is selected in accordance with a determination that the respective similarity level of the reference image is higher than the respective similarity level of each alternative image.

19. A computer system, comprising:
one or more processors; and
memory storing one or more programs for execution by the one or more processors, the one or more programs further comprising instructions for:
obtaining a first image including an object, the first image associated with a physical environment;
applying a reference model to process the first image and generate a reference label;
applying an image generative model to generate a reference image based on the reference label;
in accordance with a determination that the first image and the reference image satisfy a similarity criterion, labelling the first image with the reference label; and
adding the first image that is labelled with the reference label to a corpus of training data to be used to generate a target model for autonomously monitoring the physical environment.

20. A non-transitory computer-readable storage medium, storing one or more programs for execution by one or more processors, the one or more programs further comprising instructions for:
obtaining a first image including an object, the first image associated with a physical environment;
applying a reference model to process the first image and generate a reference label;
applying an image generative model to generate a reference image based on the reference label;
in accordance with a determination that the first image and the reference image satisfy a similarity criterion, labelling the first image with the reference label; and
adding the first image that is labelled with the reference label to a corpus of training data to be used to generate a target model for autonomously monitoring the physical environment.
